(19) United States
(12) Patent Application Publication
(10) Pub. No.: US 2007/0092676 A1
(43) Pub. Date: Apr. 26, 2007

(54) Peelable confidential security adhesive tape structure

(76) Inventor: Shen-Nan Kan, Taipei Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/258,239

(22) Filed: Oct. 26, 2005

(51) Int. Cl. B32B 33/00

(52) U.S. Cl. 428/40.1; 428/354

(57) ABSTRACT

A peelable confidential security adhesive tape structure comprises an adhesive tape and a thrust runner for receiving said tape; wherein said thrust runner is provided with two opposite stoppers on the upper side of said thrust runner; wherein said tape contains a plurality of individual confidential security films, wherein each film has its bottom surface provided with an adhesive-free manual part, wherein manual parts on the adjacent upper and lower layers are stacked alternately over the front and rear. When the outermost film of the adhesive tape is peeled off upwardly from the manual part, the glue on the bottom surface of the film can pull the manual part of the underlying film upwardly and places the manual part on the stopper for lifting successively those underlying films. Further, when said film stuck on an object is peeled away, warning character or pattern can be displayed. Said peelable confidential security adhesive tape is useful as a confidential security adhesive tape and its individual films can be peeled successively.

### BACKGROUND OF THE INVENTION

1. Field of the Invention

The invention relates to a peelable confidential security adhesive tape structure, and more particularly, to a peelable confidential security adhesive tape structure consisting of a plurality of confidential security films that are laminated alternately and can be pulled out successively by using a thrust runner, characterized in that it can increase efficiency in use. And, after sticking on an object, the adhesive tape can be readily peeled away and can achieve an effect of confidential security, and is suitable for using as a confidential security adhesive tape peelable successively.

2. Description of the Prior Art

A variety of security adhesive tapes has been developed and appeared on the market for obtaining a confidential effect. Common security adhesive tape is based mainly on sticker (as shown in FIG. 12), that is, a sticker that can stick on an anti-adhesion release film a, and that consists of a plurality of aligned security tapes b, whereby excess materials between such security adhesive tapes b are removed by a trimming process such that a user can use these security adhesive tapes b one piece by one piece.

The above-described sticker-like security adhesive tapes b has a security effect to achieve the confidential purpose. Nevertheless, in practical use, it has many disadvantages to be improved as follows:
1. In the fabrication of such sticker-like security adhesive tapes, the formation of excess materials between adhesive tapes would cause waste materials and the additional step of ripping those excess materials would increase the relative costs of the labor and time.
2. As each security adhesive tapes sticker simultaneously on just one piece of release film that has its length and width much larger than those of each single adhesive tape, a relative large space is required for its storage and the product tends to crease.
3. In the use of large amount of the security adhesive tapes, those adhesive tapes are required to peel off one piece by one piece, and hence much time and labor must be consumed.
4. Once the security adhesive tapes sticking on an object, an overall binding will occur that might increase the difficulty in ripping the bound adhesive tapes due to the absence of any free end on the adhesive tapes.

In view of the foregoing, in order to improve the above-mentioned disadvantages such that not only the peelable confidential security adhesive tape structure can be stacked in a form of single piece to avoid the generation of any excess material and hence to decrease the waste material, save time, and peel off the confidential security adhesive tape one piece by one piece to increase efficiency in use, but also the adhesive tape bound over an object can be readily peeled off, the inventor had devoted to research and develop constantly based on his abundant experience, and eventually, accomplished the present invention.

### SUMMARY OF THE INVENTION

The main objective of the invention is to provide a peelable confidential security adhesive tape structure characterized in that its adhesive tape is formed by stacking a plurality of individual security films to eliminate the generation of any excess material and hence can decrease waste material and save space for storage.

Another objective of the invention is to provide a peelable confidential security adhesive tape structure characterized in that, by stacking alternately a plurality of individual confidential security films, and using them in conjunction with a thrust runner, these films can be peeled off successively such that the efficiency in use can be increased and further, once sticking on an object, the film can be peeled off readily.

In order to achieve the above-mentioned objectives of the invention, the peelable confidential security adhesive tape structure provided by the invention comprises an adhesive tape and a thrust runner. Said adhesive tape contains a plurality of individual films, wherein each film has its top surface coated with a non-adhesive release agent, and has its bottom surface provided with an adhesive-free manual part, wherein manual parts on the adjacent upper and lower layers are stacked alternately over the front and rear. A separation layer having printed character or pattern is provided at the other end of the bottom surface of the film, wherein said separation layer has a printing ink layer coated on its lower part. A glue layer is provided under said printing ink layer for sticking on an object. Once the film is peeled off, said separation layer can display a warning pattern or character on the object. Further, said thrust runner is provided with an accommodating space for receiving said films and with two opposite stoppers on its upper part. When the outermost film of the adhesive tape is peeled off upwardly from the manual part, the glue on the bottom surface of the film can pull the manual part of the underlying film upwardly and places the manual part on the stopper for lifting successively those underlying films.

### BRIEF DESCRIPTION OF THE DRAWINGS

These features and advantages of the present invention will be fully understood and appreciated from the following detailed description of the accompanying drawings.

FIG. 1 is a schematic view showing the use of the peelable confidential security adhesive tape structure according to an embodiment of the invention;

FIG. 2 is an elemental exploded view of the peelable confidential security adhesive tape structure according to an embodiment of the invention;

FIG. 3 is a section view of the peelable confidential security adhesive tape structure according to an embodiment of the invention;

FIG. 4 is a schematic view showing the use of the peelable confidential security adhesive tape structure according to another embodiment of the invention;

FIG. 5 is a three-dimensional exterior view of the thrust runner in the peelable confidential security adhesive tape structure according to one embodiment of the invention;

FIG. 6 is a three-dimensional exterior view of the thrust runner in the peelable confidential security adhesive tape structure according to another embodiment of the invention;

FIG. 7 is a three-dimensional exterior view of the thrust runner in the peelable confidential security adhesive tape structure according to yet another embodiment of the invention;

FIG. 8 is a three-dimensional exterior view of the thrust runner in the peelable confidential security adhesive tape structure according to still yet another embodiment of the invention;

FIG. 9 is a schematic view showing the use of the peelable confidential security adhesive tape structure according to yet another embodiment of the invention;

FIG. 10 is a combinatorial exploded view showing the presence of separation liquid between a printing ink layer and a glue layer in a peelable confidential security adhesive tape structure according to an embodiment of the invention; and

FIG. 11 shows the state in using the structure shown in FIG. 10.

FIG. 12 is a schematic view of a conventional sticker-like security adhesive tape.

In order to understand better the invention, a detailed description is provided below.

### DETAILED DESCRIPTION OF THE PREFERRED EMBODIMENT

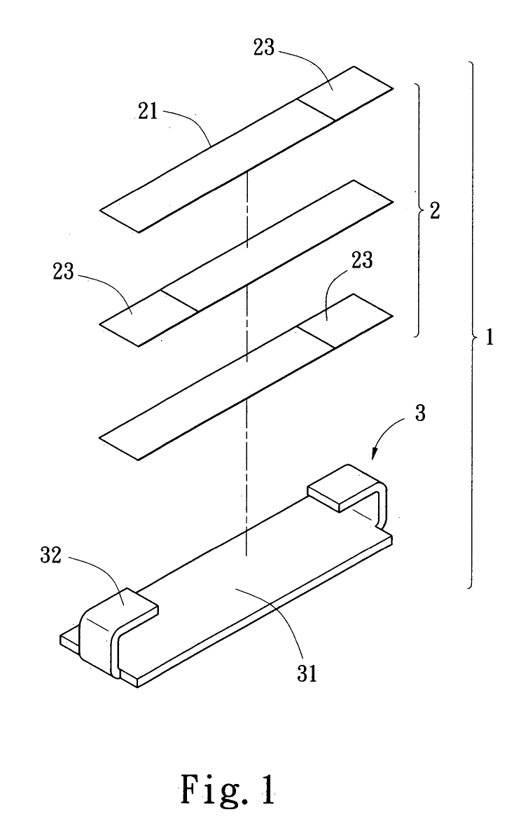

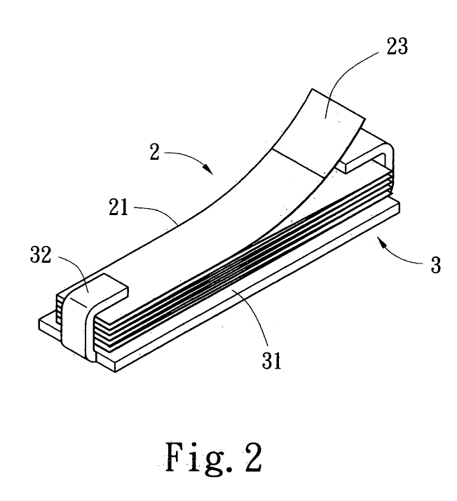

Referring to FIGS. 1˜3, a peelable confidential security adhesive tape structure 1 according to a preferred embodiment of the invention comprises a adhesive tape 2 and a thrust runner 3.

Said adhesive tape 2 contains a plurality of elongated strip-like films 21, wherein the top surface of each film 21 is coated with a release agent 22, and the bottom surface of the film 21 is provided with a manual part 23, with manual parts of adjacent upper and lower layers being stacked alternately over the front and rear, and said manual part 23 can be configured as different colors as needed. Said film 21 is provided further on another end of its bottom surface with a separation layer 24 having a printing character or pattern, wherein a printing ink layer 25 is applied beneath said separation layer 24, and a glue layer 26 is provided beneath said printing ink layer 25.

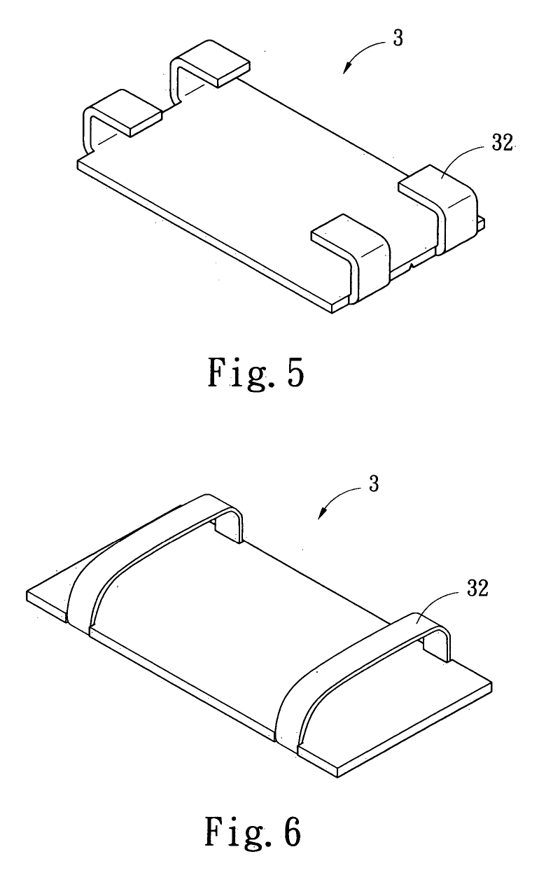

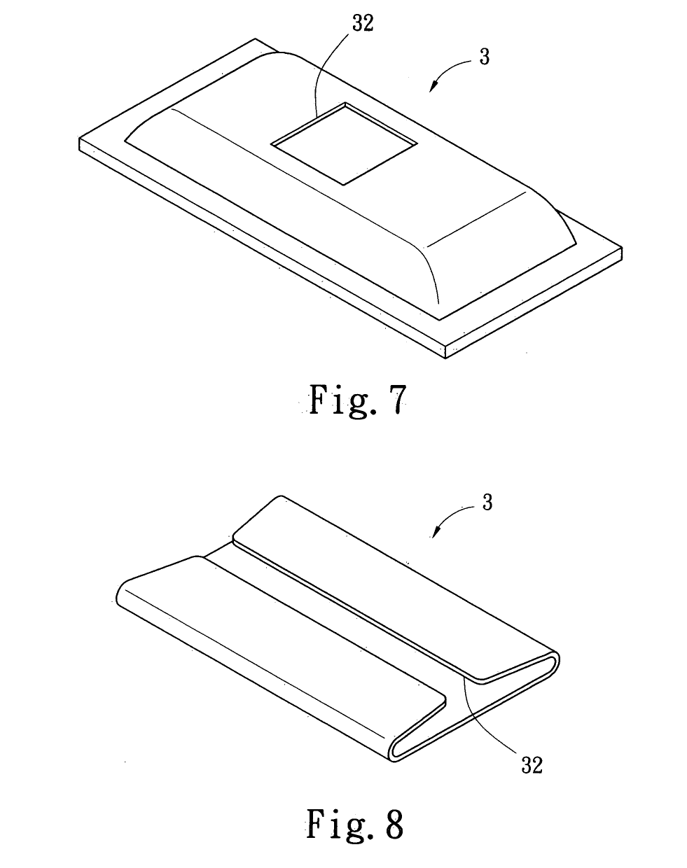

Said thrust runner 3 is provided with an accommodating space 31 for receiving an adhesive tape 2, wherein the thrust runner 3 is provided on its upper side with two opposite stoppers 32 in a manner that one stopper 32 is provided on one end of the upper side of said adhesive tape 2. As one film 21 on the outermost layer of the adhesive tape 2 is lifted from the manual part 23, the glue layer 26 on the bottom surface of the adhesive tape 21 can lift the manual part 23 of the underlying adhesive tape 21 to place it on a stopper 31 for subsequent lifting this underlying adhesive tape 21 (as shown in FIG. 4). Further, in various forms of the thrust runner 3 shown in FIGS. 5˜8, two opposite stoppers 32 are similarly provided on its upper side to achieve the effect of lifting the film 21 successively.

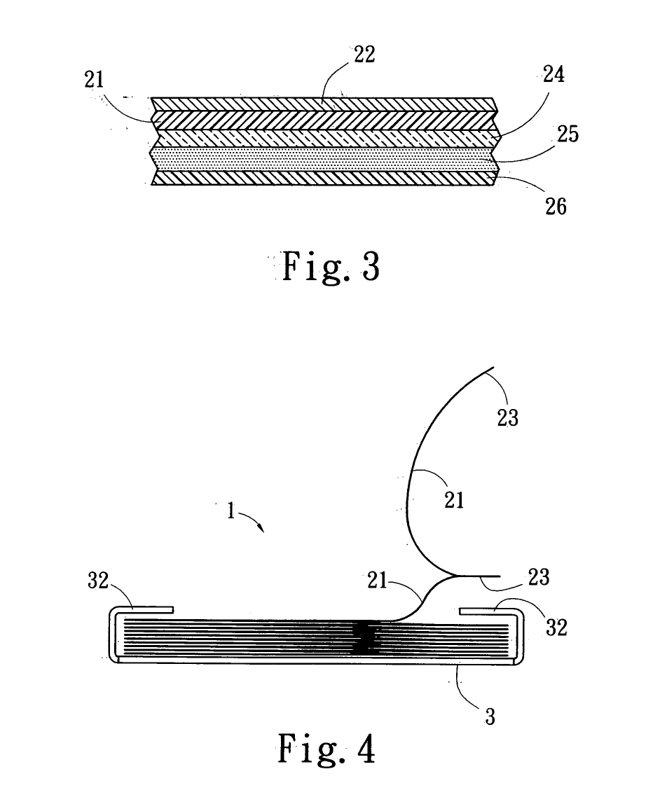

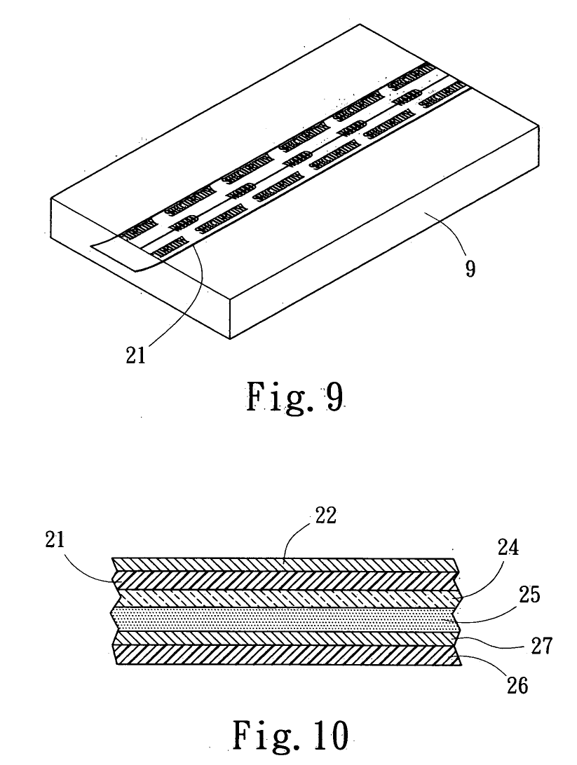

Referring to FIGS. 3 and 9, said separation layer 24 is composed of a clear separation liquid and printed characters. When the film 21 is peeled off, since the adhesion force of the printed characters or pattern to the film 21 is greater than the adhesion force of the separation layer 24 to the glue layer 26, the object 9 can bind with the glue layer 26, and may be peeled from the separation layer 24 and hence displays the printed characters or pattern on the separation layer 24 to produce a warning effect. When the film 21 binds to the object 9 again, printed characters on the film 21 can not flush with those on the object 9, and is in an alternate state, thus indicating that said object 9 has been opened, and hence a warning and confidential security effect can be obtained.

As the above-described glue layer 26 is peeled off said object 9, said glue layer 26 sticks still on said object 9, and can stick back again. When the glue layer 26 is made of the same material of the peelable object 9, said glue layer 26 can be peeled together with the film 21 away from said peelable object 9 without any residual glue. While the printed characters or patterns present between the film 21 and the glue layer 26 can be separated and re-combined during peeling the object 9, they can not flush with each other but in alternate state, despite of being present still between the film 21 and the glue layer 26.

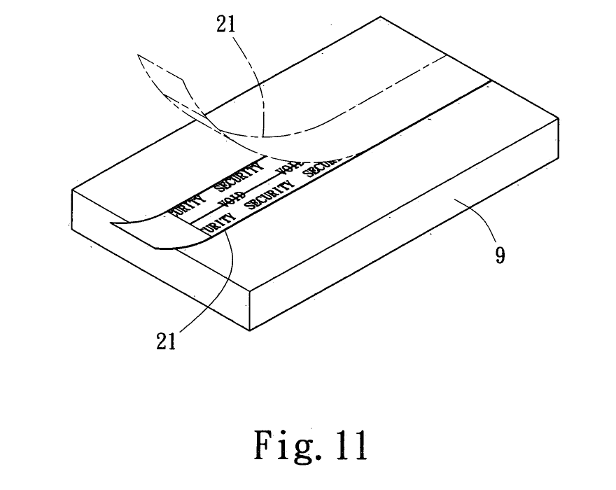

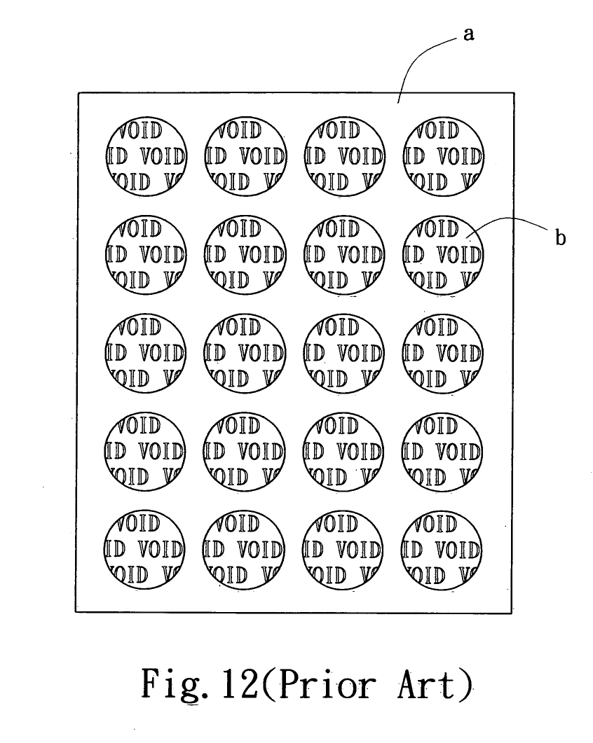

Referring to FIGS. 10 and 11, in another embodiment of the peelable confidential security adhesive tape 2, a separation liquid 27 is applied between the printing ink layer 25 and the glue layer 26. Once the film 21 being peeled apart, the printed characters or pattern on the separation layer 24 could be likewise exposed to produce the warning effect. Furthermore, by means of the barrier from the separation liquid 27, the film 21 can not bind again with the object 9 and hence is present in an open state.

Accordingly, the invention exhibits following advantages:
1. The adhesive tape provided by the invention contains a plurality of stacked individual confidential security films, which can eliminate effectively the generation of spent materials, and hence decreases waste materials, and in addition, can save space for storage.
2. The adhesive tape is used in conjunction with a thrust runner that can lift successively the film, thereby not only the efficiency in use can be greatly increased, but also the film can be peeled readily once it stuck on an object without needing to find out the head end of the tape sheet as in the conventional structure.
3. The confidential security adhesive tape according to the invention can be provided in different colors depending on the rank of confidentiality, thereby provides the effect of labeling by classification.
4. The confidential security adhesive tape according to the invention can be provided in different types for applying in conjunction with different type of thrust runner, thereby imparts flexibility in use.

Therefore, in view of the foregoing, the invention can attain the intended objects, and provides a peelable confidential security adhesive tape that is produced by stacking individual film, whereby no spent materials can be generated and hence can eliminate waste materials, save space for storage, the individual confidential security film can be peeled on piece by one piece successively to increase the efficiency in use, while the film can be peeled off readily after being stuck on an object. Thus, the peelable confidential security adhesive tape according to the invention can provide extremely practical value.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A peelable confidential security adhesive tape structure, comprises:
an adhesive tape, containing a plurality of individual confidential security films, wherein each film has its top surface coated with a non-adhesive release agent, and has its bottom surface provided with an adhesive-free manual part, wherein manual parts on the adjacent upper and lower layers are stacked alternately over the front and rear, wherein a separation layer having printed character or pattern is provided at the other end of the bottom surface of the film, wherein said separation layer has a printing ink layer coated on its lower part, wherein a glue layer is provided under said printing ink layer for sticking on an object, and wherein, after the film being peeled off, said separation layer can display a warning pattern or character on the object; and
a thrust runner, provided with an accommodating space for receiving said films and with two opposite stoppers on the upper side of said thrust runner, wherein, when the outermost film of the adhesive tape is peeled off upwardly from the manual part, the glue on the bottom surface of the film can pull the manual part of the underlying film upwardly and places the manual part on the stopper for lifting successively those underlying films.

2. A peelable confidential security adhesive tape structure as in claim 1, comprises further a separation liquid between said printing ink layer and said glue layer, thereby, after displaying the printed character on said separation layer, no further binding can be occurred.

3. A peelable confidential security adhesive tape structure as in claim 1, wherein once the glue layer is peeled away said object, the printed character and pattern present between said film and said glue layer is separated in two parts during said peeling from said object, and these two parts can not aligned upon re-binding and is in an alternate state.

4. A peelable confidential security adhesive tape structure as in claim 1, wherein said separation layer is composed of printed characters or pattern in admixture with a separation liquid.
